(19) United States
(12) Patent Application Publication
(10) Pub. No.: US 2011/0227514 A1
(43) Pub. Date: Sep. 22, 2011

(54) EDDY-CURRENT MAGNETIC CONTROLLED LOADING DEVICE USED IN A MAGNETIC CONTROLLED POWER GENERATOR

(75) Inventors: MING-YU LEE, TAIPEI (TW); YU-HSING HUANG, TAIPEI (TW)

(73) Assignee: SHIHLIN ELECTRIC & ENGINEERING CORP., TAIPEI (TW)

(21) Appl. No.: 12/726,845

(22) Filed: Mar. 18, 2010

(51) Int. Cl. H02P 3/14

(52) U.S. Cl. 318/376

(57) ABSTRACT

An eddy-current magnetic controlled loading device used in a magnetic controlled power generator, including a frame, an eddy-current magnetic controlled loading device, a flywheel, a rotary axle for supporting the flywheel, and a magnetic controlled device. The eddy-current magnetic controlled loading device includes: a rotor coupled to the rotary axle and positioned in the flywheel, the rotor having a rotor core and several pieces of permanent magnets arranged on outer circumference of the rotor core, the rotary axle being rotatable to drive and rotate the flywheel and the rotor; and a stator fixed on the frame and coaxially disposed outside the rotor. The stator has a stator core and multiple radial projections arranged on inner circumference of the stator core. A gap between crown sections of the projections is smaller than a gap between root sections of the projections, whereby a previously wound coil can be fitted onto the projections.

### BACKGROUND OF THE INVENTION

1. Field of the Invention

The present invention relates generally to an eddy-current magnetic controlled loading device, and more particularly to an eddy-current magnetic controlled loading device used in a magnetic controlled power generator.

2. Description of the Related Art

There are various conventional exercise equipments including treadmills, exercise bikes, steppers, etc. In operation of any such exercise equipment, a user can use his/her feet, hands or other parts of the body to move an operation mechanism of the exercise equipment, (for example, the track of a treadmill, the sprocket of an exercise bike, the pedals of a stepper, the handles of a power rower). The operation mechanism then drives a flywheel to rotate. When operating the exercise equipment to simulate running, stepping or rowing, under the inertia of the flywheel, the load exerted on the user can be increased to enhance exercise intensity.

In order to meet the demands of all kinds of users with different fitness and exercise intensities, the exercise equipment is generally provided with a resistance adjustment mechanism for changing the load on the user or the resistance against operation of the exercise equipment. Accordingly, the exercise intensity is adjustable in accordance with the requirements of different users.

Recently, magnetic resistance adjustment mechanism has become a main stream of the resistance adjustment mechanisms of the gymnastic/rehabilitative equipments. The magnetic resistance adjustment mechanism can be combined with a power generator to form a generally so-called “magnetic controlled power generator”. The magnetic controlled power generator operates on a principle that a user treads the pedals to create mechanical energy. Afterwards, through a transmission member such as a belt or a chain, an eddy-current magnetic controlled loading device is driven to convert the mechanical energy into current. Through a power converter unit, the current generated by the magnetic controlled power generator is supplied to the electronic units of the gymnastic/rehabilitative equipment such as a microcomputer, a control panel and a magnetic resistance unit that necessitate power.

Please refer to FIGS. 1A and 1B. The above magnetic controlled power generator includes: a frame 10 having a front plate 11 and a rear plate 12; a rotor 13 composed of a flywheel 14 and several pieces of permanent magnets 15 arranged on an inner circular edge of the flywheel 14; a stator 16 fastened on the frame 10 inside the rotor 13; a rotary axle 17 passing through the required bearings for supporting the flywheel 14, a drive wheel 18 being mounted at one end of the rotary, axle 17 for driving the rotary axle 17 and the flywheel 14 to rotate, whereby the flywheel 14 can be driven and rotated about the stator 16 to form a self-power generating system; a magnetic controlled unit 19 fastened on the rear plate 12 in adjacency to the flywheel 14. After powered on, an induced eddy current is generated between the flywheel 14 and the stator 16 to produce a magnetic field and cause a magnetic resistance against the flywheel 14 as an effective motion loading on the user in operation of the gymnastic/rehabilitative equipment.

Referring to FIG. 1C, the stator 16 includes a stator core 16A having multiple radial projections 16B arranged on a surface of outer wall of the stator core 16A. Coils 16C are wound around the projections 16B of the stator core 16A at intervals in accordance with the distribution of phase number and pole number of the power generator. FIG. 1C shows a typical example of a three-phase power generator having 12 poles. Accordingly, 36 projections 163 are circumferentially arranged on the surface of the outer wall of the stator core 16A and a coil 16C is wound around each three projections 16B as a unit. In this case, totally 12 coils are mounted on the stator core 16A to form 12 poles.

However, some defects exist in the structural relationship between the aforesaid rotor 13 and stator 16. First, the rotor 13 is positioned outside the stator 16 so that the inner diameter of the permanent magnets 15 needs to be larger than the outer diameter of the stator 16. As a result, the rotor 13 has a considerably large volume and a pretty heavy weight. This leads to very large volume and heavy weight of the magnetic controlled power generator and needs to be improved.

Second, the radial projections 16B are circumferentially arranged on the surface of the outer wall of the stator core 16A. Therefore, the gap D1 between the crown sections of the projections 16B is larger than the gap D2 between the root sections of the projections 16B. Under such circumstance, when mounting the coils 16C, it is impossible to directly fit previously wound coils 16C onto the root sections of the projections 16B. Instead, it is necessary to wind the coils 16C on the root sections of the projections 16B one by one with a winding machine. Such winding process is quite troublesome and time-consuming and needs to be improved.

### SUMMARY OF THE INVENTION

A primary object of the present invention is to provide an eddy-current magnetic controlled loading device with minified volume as a whole.

A further object of the present invention is to provide the above eddy-current magnetic controlled loading device the manufacturing process of which is simplified. Moreover, the assembling/installation rate of the eddy-current magnetic controlled loading device is promoted.

To achieve the above and other objects, the eddy-current magnetic controlled loading device is applicable to a magnetic controlled power generator. The magnetic controlled power generator includes: a frame; an eddy-current magnetic controlled loading device; a flywheel having an internal circular cavity; a rotary axle passing through required bearings for supporting the flywheel, a drive wheel being disposed at one end of the rotary axle for driving the rotary axle and the flywheel to rotate; and a magnetic controlled device installed on the frame in adjacency to the flywheel. The eddy-current magnetic controlled loading device includes: a rotor coupled to the rotary axle and positioned in the cavity of the flywheel, the rotor having a rotor core and several pieces of permanent magnets arranged on outer circumference of the rotor core, the rotor and the flywheel being together mounted on the rotary axle, whereby when the drive wheel is rotated, the drive wheel drives the flywheel and the rotor to rotate; and a stator fixed on the frame and coaxially disposed outside the rotor. The stator has a stator core and multiple radial projections arranged on an inner circumference of the stator core. A gap between the crown sections of the projections is smaller than a gap between the root sections of the projections, whereby a previously wound coil can be directly fitted onto the projections of the stator. When the rotor rotates relative to the stator, the magnetic field of the rotor is rotated relative to the coil of the stator, whereby a voltage is generated to produce a current that flows through the coil. The magnetic controlled device is controllable by the current flowing through the coil to increase a load on the flywheel in rotation.

In practice, the diameters of the flywheel, the rotor and the stator are minified so as to reduce the volume and weight of the magnetic controlled power generator. In this case, the previously wound coil can be directly fitted onto the projections of the stator to simplify the manufacturing process of the magnetic controlled power generator.

### BRIEF DESCRIPTION OF THE DRAWINGS

The structure and the technical means adopted by the present invention to achieve the above and other objects can be best understood by referring to the following detailed description of the preferred embodiment and the accompanying drawings, wherein:

FIGS. 1A and 1B are a sectional view and a perspective exploded view of a conventional magnetic controlled power generator respectively;

FIG. 1C is a sectional view of a conventional stator;

FIGS. 2 and 3 are a sectional view and a perspective exploded view of the eddy-current magnetic controlled loading device of the present invention respectively;

FIG. 4 is a sectional view of the stator of the present invention; and

FIGS. 5 and 6 are a sectional view and a perspective exploded view showing that the eddy-current magnetic controlled loading device of the present invention is applied to a magnetic controlled power generator.

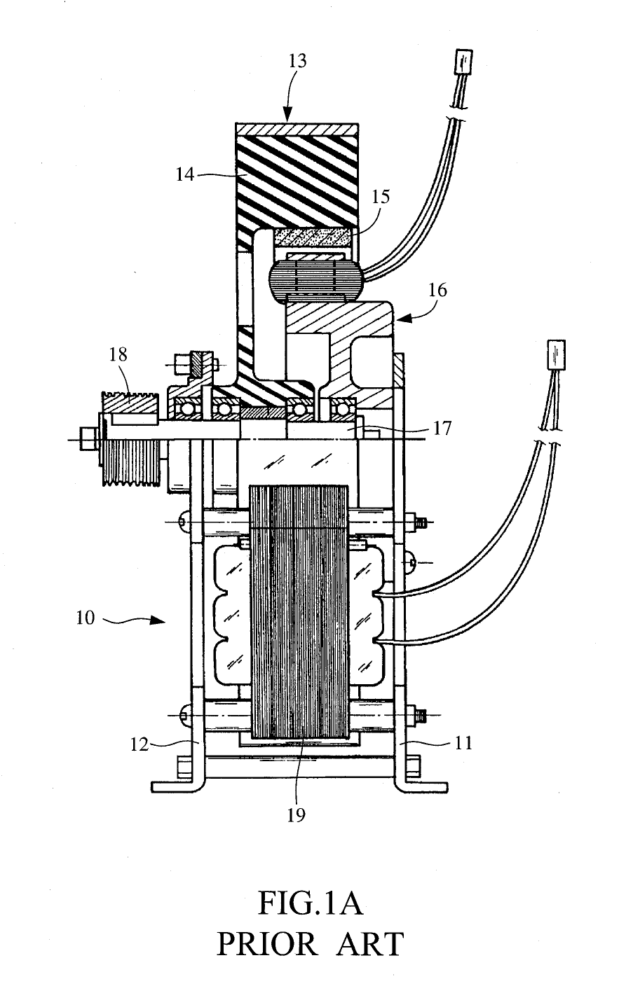

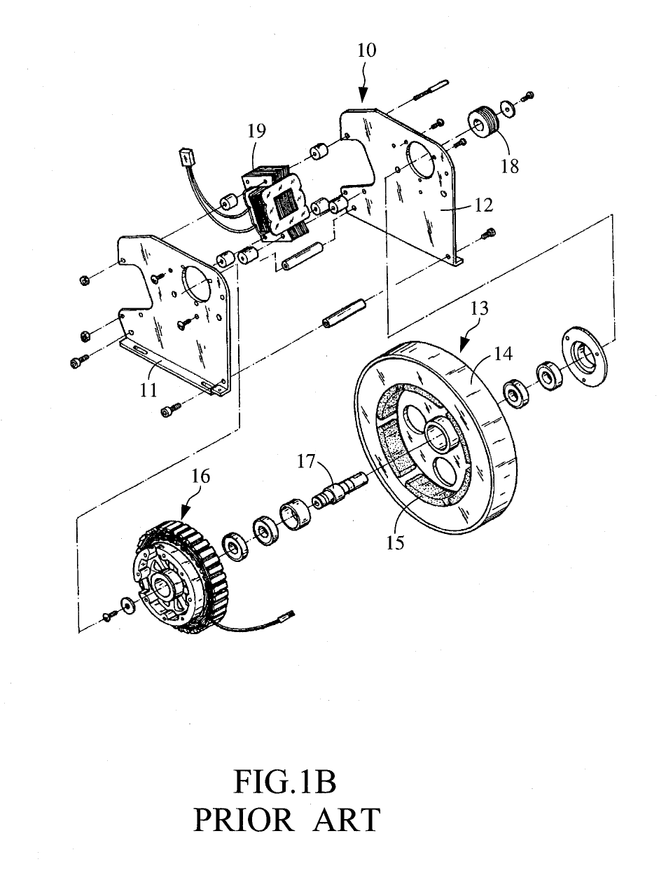

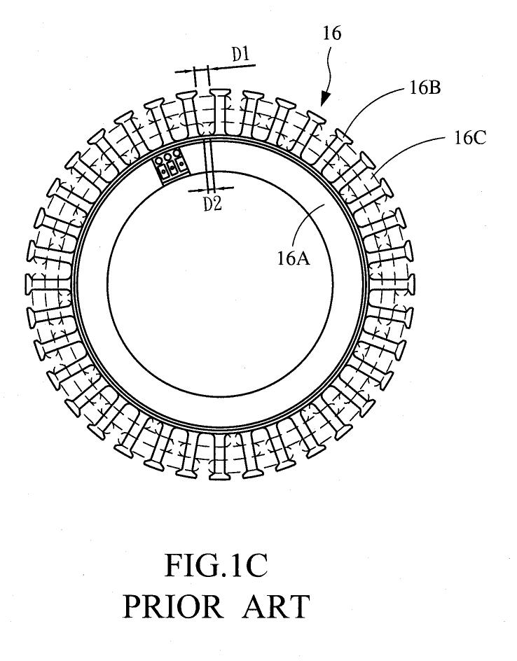

### DETAILED DESCRIPTION OF THE PREFERRED EMBODIMENT

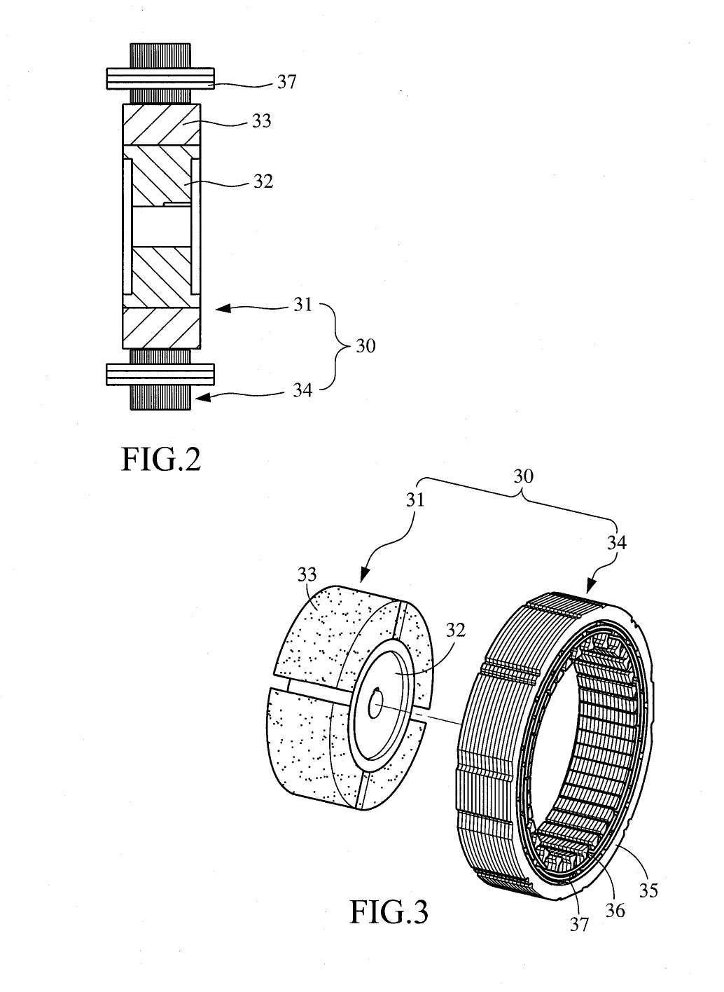

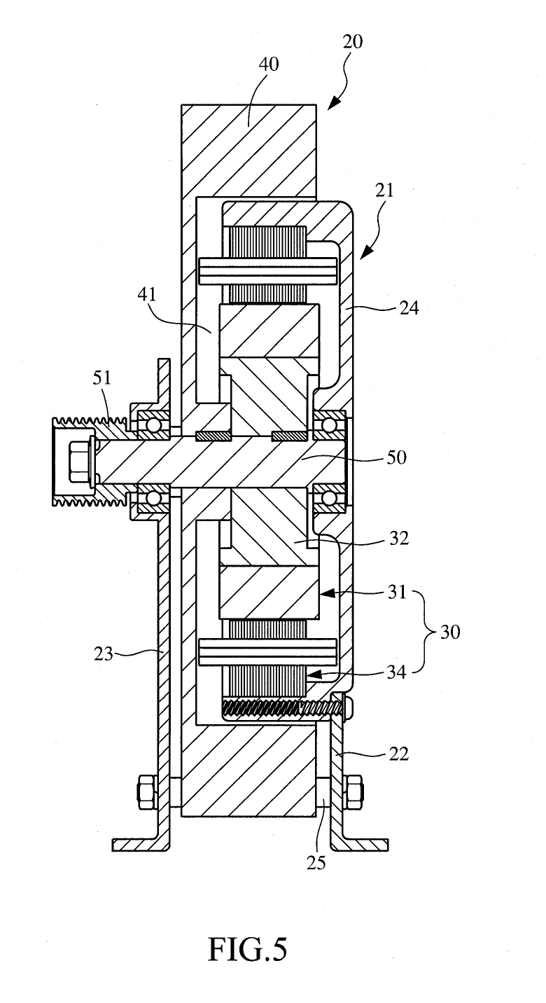

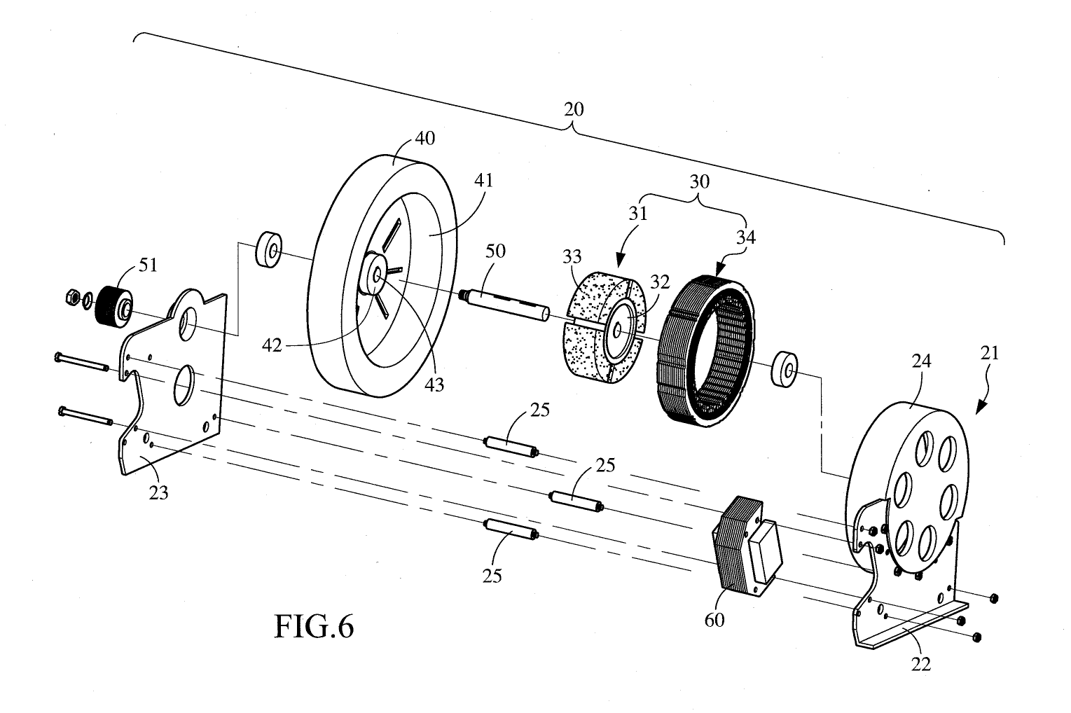

FIGS. 2 and 3 respectively are a sectional view and a perspective exploded view of the eddy-current magnetic controlled loading device used in the magnetic controlled power generator of the present invention. Please refer to FIGS. 5 and 6. The magnetic controlled power generator 20 includes: a frame 21; an eddy-current magnetic controlled loading device 30; a flywheel 40 formed with vents as a fan for air circulation and enhancement of heat dissipation efficiency; a rotary axle 50; and a magnetic controlled device 60. The frame 21 has a first bracket 22 and a second bracket 23. A reception body 24 is connected to a top end of the first bracket 22. The first and second brackets 21, 22 are interconnected by means of a plurality of fastening rods 25 with the same length. The flywheel 40 has an internal circular cavity 41 with a hub section 42. The hub section 42 has a passage 43 dimensionally adapted to receive the rotary axle 50. The rotary axle 50 passes through the required bearings for supporting the flywheel 40. A drive wheel 51 is disposed at one end of the rotary axle 50 for driving the rotary axle 50 and the flywheel 40 to rotate. The magnetic controlled device 60 is installed on an inner face of the first bracket 22 in adjacency to the flywheel 40.

Referring to FIGS. 2, 3, 5 and 6, the eddy-current magnetic controlled loading device 30 includes a rotor 31 coupled to the rotary axle 50 and positioned in the cavity 41 of the flywheel 40 and a stator 34 disposed outside the rotor 31 and fixed in the reception body 24 of the frame 21. When the rotor 31 rotates relative to the stator 34, a magnetic circuit is formed to produce alternating current. The alternating current is converted by a power converter circuit and then supplied to the magnetic controlled device 60. At this time, an induced eddy current is generated to produce a magnetic field and cause a greater magnetic resistance against the flywheel 40 as a braking force. Accordingly, when operating the gymnastic/rehabilitative equipment, the load on a user can be variably increased to adjust the exercise intensity.

The rotor 31 and the flywheel 40 are together mounted on the rotary axle 50. Therefore, when a user pedals the pedals of gymnastic/rehabilitative equipment, a transmission member, such as a belt or a chain (not shown), of the gymnastic/rehabilitative equipment is driven to drive the drive wheel 51, such as a belt wheel or a sprocket, mounted on the rotary axle 50. Consequently, the drive wheel 51 is rotated to drive and rotate the flywheel 40 and the rotor 31.

The rotor 31 has a rotor core 32 and several pieces of permanent magnets 33 arranged on outer circumference of the rotor core 32.

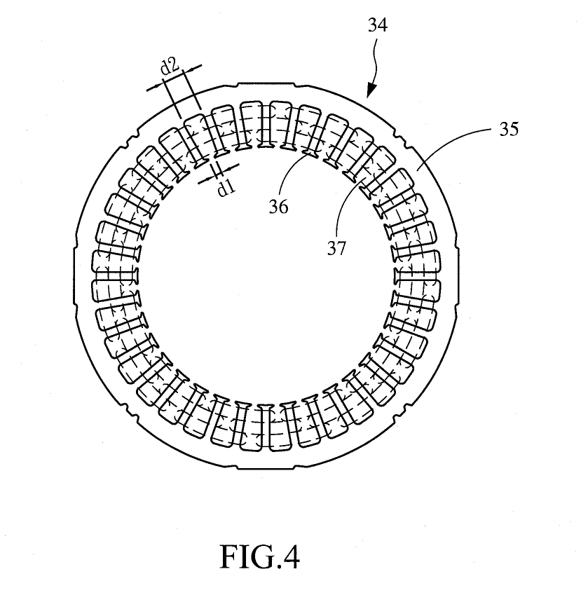

Referring to FIGS. 4 and 5, the stator 34 has a stator core 35 and multiple radial projections 36 arranged on an inner circumference of the stator core 35. In this case, the gap d1 between the crown sections of the projections 36 is smaller than the gap d2 between the root sections of the projections 36. Under such circumstance, the gap d1 between the crown sections will be also smaller than the inner diameter of the coil 37. Accordingly, the previously wound coils 37 can be easily fitted onto the root sections of the projections 36 to simplify the manufacturing process and promote the assembling rate. The stator 34 is fixedly disposed in the reception body 24 of the frame 21. Therefore, when the rotor 31 rotates relative to the stator 34, the magnetic field of the rotor 31 is rotated relative to the coils 37 of the stator 34. At this point, a voltage is generated to produce a current that flows through the coils 37. The magnetic controlled device 60 is controllable by the current flowing through the coils 37 to increase the load on the flywheel 40 in rotation.

The present invention is mainly characterized in that the rotor 31 is positioned inside the stator 34 so that the volume of the magnetic controlled power generator is minified. Therefore, the magnetic controlled power generator is miniaturized and weight-reduced to overcome the defect of large volume of the conventional magnetic controlled power generator in which the rotor is positioned outside the stator. Moreover, the previously wound coils 37 can be directly fitted onto the projections 36 of the stator 34 to complete the assembling operation. Accordingly, the manufacturing process is simplified and the assembling/installation rate is promoted to solve the problem of inconvenience in winding the coils on the projections of the conventional stator one by one with a winding machine.

The above embodiment is only used to illustrate the present invention, not intended to limit the scope thereof. It is understood that many changes or modifications of the above embodiment can be made by those who are skilled in this field without departing from the spirit of the present invention. The scope of the present invention is limited only by the appended claims.

What is claimed is:

1. An eddy-current magnetic controlled loading device used in a magnetic controlled power generator, the magnetic controlled power generator including: a frame; an eddy-current magnetic controlled loading device; a flywheel having an internal circular cavity; a rotary axle passing through required bearings for supporting the flywheel, a drive wheel being disposed at one end of the rotary axle for driving the rotary axle and the flywheel to rotate; and a magnetic controlled device installed on the frame in adjacency to the flywheel, the eddy-current magnetic controlled loading device comprising:
a rotor rotatably coupled to the rotary axle and positioned in the cavity of the flywheel, the rotor having a rotor core and several pieces of permanent magnets arranged on outer circumference of the rotor core, the rotor and the flywheel being together mounted on the rotary axle, whereby when the drive wheel is rotated, the drive wheel drives the flywheel and the rotor to rotate; and
a stator fixed on the frame and coaxially disposed outside the rotor, the stator having a stator core and multiple radial projections arranged on an inner circumference of the stator core, a gap between crown sections of the projections being smaller than a gap between root sections of the projections, whereby a previously wound coil can be directly fitted onto the projections of the stator, when the rotor rotates relative to the stator, magnetic field of the rotor being rotated relative to the coil of the stator, whereby a voltage is generated to produce a current that flows through the coil, the magnetic controlled device being controllable by the current flowing through the coil to increase a load on the flywheel in rotation.

2. The eddy-current magnetic controlled loading device used in the magnetic controlled power generator as claimed in claim 1, wherein the frame has a first bracket and a second bracket, which are interconnected by means of a plurality of fastening rods with the same length, a reception body being connected to a top end of the first bracket and positioned in the flywheel for receiving the stator.
